(19) United States
(12) Patent Application Publication
(10) Pub. No.: US 2006/0178901 A1
(43) Pub. Date: Aug. 10, 2006

(54) Home movies television (HMTV)

(76) Inventor: Kelana Lynnette Cooper, Houston, TX (US)

Correspondence Address: Kelana L. Cooper, 15903 Breanna Lane, Houston, TX, 77049, US

(21) Appl. No.: 11/325,852

(22) Filed: Jan. 5, 2006

Related U.S. Application Data
(60) Provisional application No. 60/641,625, filed on Jan. 5, 2005.

(51) Int. Cl. G06Q 99/00

(52) U.S. Cl. 705/1

(57) ABSTRACT

The purpose of home movies television is to bring pirating to an end. This invention was developed to allow the public access to new release movies currently in theatres from home. METHODS: The main components of this invention would include a motion detector and the HMTV unit. The motion detector is designed to track the number of individuals present if increased the detector sends a signal to the unit that number of individuals paid does not match the number of individuals present. The HMTV unit is equipped with a smart chip. This allows the detection of recording devices and all customer service needs. RESULTS: This invention will give the movie industry the ability to monitor the number individuals present while attempting to eliminate the need for pirating. CONCLUSION: This invention gives the consumer what is desired to view a newly released movie from home.

The purpose of HMTV system is to bring pirating to an end.

A process has been developed that would allow the public access to Newly Released movies from theatres to the comfort of home. These are not movies that you can currently rent from a movie rental store or through your cable provider.

HMTV system CAN be used through your local cable company or through your telecommunications provider.

Through the cable company it can be accessible through the cable network something similar to pay per view. Through a telecommunications or internet provider HMTV would work just as your local internet would. Home Movies Television. Is a two-part invention. The first part is a box similar to a DVD player. This box gives you the ability to watch the Newly Released Movies, which would normally go directly to the theatres. This box allows you to select your movie and pay for the individuals attending the viewing. Part 2 is a motion detector that uses infrared technology to monitor the number of individuals present, while scanning the room for recording devices.

To the Commissioner of Patents and Trademarks:

Your petitioner, Kelana L. Cooper and Patrina Y Frederick a citizen of United States and a resident of Houston, Tex., prays that letters patent may be granted for the design for Home Movies Television as set forth in the following specification:

FIG. 1 is a top plan view of a family watching a newly released movie showing my new design;

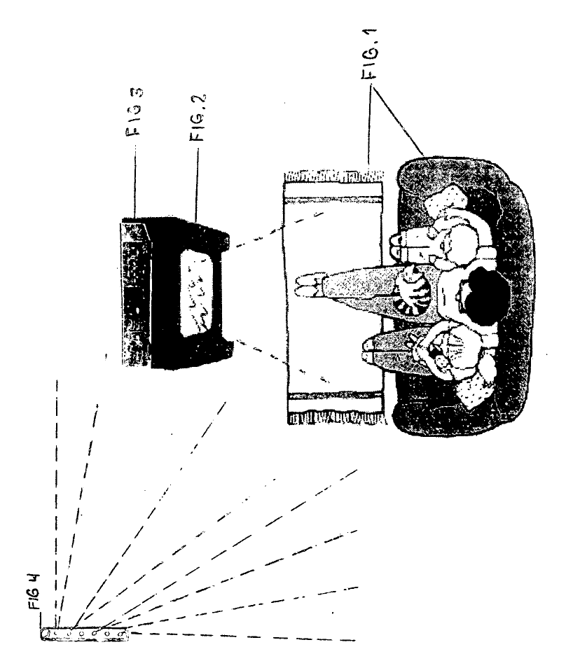

FIG. 2 is a television view thereof;

FIG. 3 is a HMTV unit view thereof;

FIG. 4 is a motion detector view thereof;

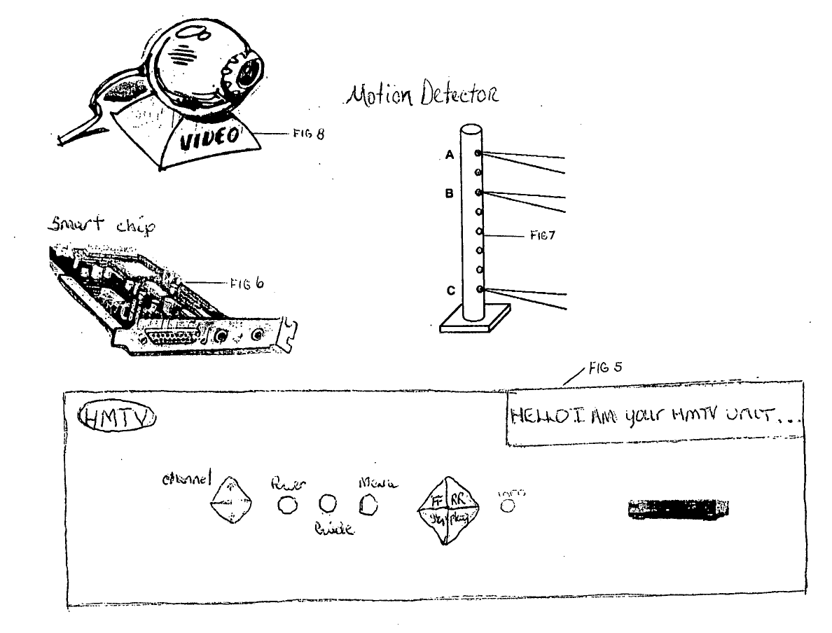

FIG. 5 is a close up view of an HMTV unit view thereof; FIG. 6 is a smart chip that allows the screen to be scrambled when there's a threat of pirating view thereof;

FIG. 7 is a example of a motion detector used in the drawing view thereof; and

FIG. 8 is a video recorder view thereof.

I claim: the ornamental design for a Home Movies Television unit and a motion detector known as HMTV, as shown.

1. This is how it works:
The HMTV system allows you to view the movie through the provider of your choice. This system is equipped with a sensor called the smart chip. This features primary responsibility is to prevent the HM movie from being recorded.
During the viewing of an HM movie, if the presence of a video recorder or other recording device is detected within the dimensions of the room. The sensor sends a signal to the television and the picture becomes scrambled. Once scrambled an advisory statement will be displayed across the screen advising customers to contact their telecommunication or cable provider provider to have their system reset. The HM technical representative will question the consumer to find out what was taken place at the time the movie was interrupted.
In order to initiate the selection and viewing of a movie, it will be necessary to contact your cable or telecommunication provider. At that time a telecommunication provider representative will ask the consumer what movie selection would they like. The number of individuals present for the movie, and the total amount that there telecommunication or cable provider account will be charged.
Once all that information has been determined, the representative will advise the consumer that the motion detector is currently scanning the room to confirm the number of individuals present. Next, the consumer will be advised to listen and acknowledge a pre-recorded disclaimer. The disclaimer will advise that at the time of commitment to the service there was an agreement with the consumer? The agreement states that if there is an attempt to record movies from the HMTV service the station will be enabled. You must contact telecommunication or cable provider for the channel to be reset.

2. How it works:
Home Movie Television system can also be programmed to be accessed with your remote control. Eliminating the need for human interaction. You select your movie and the number of individuals present for the viewing. Home Movie Television System would contain the smart chip and motion detector inside. Allowing the dimensions of the room to be scanned confirming that the number of individuals had not changed. This process provides the ultimate in entertainment while also preventing pirating.
